(19) United States
(12) Patent Application Publication
(10) Pub. No.: US 2011/0125546 A1
(43) Pub. Date: May 26, 2011

(54) SYSTEM, METHOD AND COMPUTER-USABLE MEDIUM FOR GENERATING FINANCIAL DATA BASED ON LONG TERM DEMAND DATA

(75) Inventors: Steven T. Schlonski, Webster, NY (US); Sudhendu Rai, Fairport, NY (US); Raman Padmanabhan, Pittsford, NY (US)

(73) Assignee: Xerox Corporation

(21) Appl. No.: 12/622,612

(22) Filed: Nov. 20, 2009

(51) Int. Cl. G06Q 10/00; G06Q 50/00

(52) U.S. Cl. 705/7.25; 705/348; 705/7.31

(57) ABSTRACT

A method and system for generating a multi-year variable priced outsourcing contract based on a long term demand forecast utilizing a diffusion model. Historical data comprising print requirements associated with a business process can be determined. The Bass diffusion model can be developed from such historical data in order to forecast a future print demand by estimating a number of customers migrated to an electronic presentment process. A capacity planning approach can be invoked to determine a capacity requirement that matches a projected estimate of the future print demand based on the diffusion model when the outsourcing contract is being developed. An outsourced operation cost can then be developed utilizing the capacity requirement and incorporated into the outsourcing contract. Such an approach can lead to a more optimal contract and therefore improve competitiveness of a vendor associated with such contract.

### TECHNICAL FIELD

Embodiments are generally related to data-processing systems and methods. Embodiments also relate in general to the field of computers and similar technologies, and in particular to software utilized in this field. Embodiments are additionally related to print shops and the rendering of financial documents. Embodiments are further related to the generation of multi-year variable priced contractual data based on long term demand forecasts.

### BACKGROUND OF THE INVENTION

In business it is becoming increasingly common for organizations to outsource various business processes, such as, for example, contact centers, accounting operations, human resources services, procurement, and so forth, to third party resources. Most financial institutions (e.g., banking institutions, broker/dealers, financial investment organizations, etc.), provide statement services to clients that maintain accounts with such financial institution.

A marketing department associated with such a financial institution generally collects marketing information in order to determine the requirements of a target client. Once the content of the client communication is determined, an appropriate document can be designed and the content placed onto a reporting document. Such documents may include, for example, account statements, notifications, investment reports, and the like. A particular workflow can be then designed to collect appropriate data, and a composition engine utilized to transform the data into a final document. Thereafter, the document may be configured for electronic presentment or to a print shop for physical rendering, inserting and mailing.

The majority of financial institutions outsource statement printing operations to other vendors and service bureaus. Such transaction document outsourcing may include the rendering of contracts involving, for example, statement printing written for fixed periods (e.g., 3-5 years). In order to reduce costs, financial institutions actively market the electronic presentment of such documents to their clients as an alternative to paper-based documents. Such an approach, however, does not explicitly take into account the reduction in print demand over the term of the contract as a result of migration of paper documents to an electronic presentment process. Because such financial institutions regularly market their electronic presentment capabilities to their clients, the likelihood of customers migrating to electronic statements is high. This may lead to a reduction in the production of overall printed documents in statement processing centers over time, which in turn may lead to excess capacity in the print shop and corresponding under-utilization of equipment and machine resources.

Based on the foregoing, it is believed that a need exists for an improved method and system for generating multi-year variable priced outsourcing contracts based on long term demand forecasts. A need also exists for estimating the number of adopters migrating to new technologies utilizing a diffusion model, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the disclosed embodiments to provide for an improved method and system for generating a multi-year variable priced outsourcing contract based on a long term demand forecast.

It is further aspect of the disclosed embodiments to provide for an improved method for estimating a number of adopters migrated to a new technology utilizing a diffusion model.

It is an additional aspect of the disclosed embodiments to provide for and method and system in which the demand for printed documents is estimated utilizing diffusion models and further utilized to determine print and mail capacities in subsequent years.

It is also an aspect of the disclosed embodiments to utilize demand data to estimate required (and most likely declining) print shop capacity information.

The aforementioned aspects and other objectives and advantages can now be achieved as described herein. A system and method for generating multi-year and variable financial based on long term demand forecasts utilizing a diffusion model is disclosed. Historical data comprising print requirements associated with a business process can be determined. A Bass diffusion model can be developed from such historical data to forecast future print demand by estimating the number of customers migrating to an electronic presentment technology. A capacity planning approach (e.g. LDP analysis) can be invoked to determine capacity requirements (e.g., the number of equipment, operators, shift structures, etc) that match a projected estimate of future print demand based on the employed diffusion model when the outsourcing contract is being developed. Outsourced operational costs can then be determined utilizing capacity requirements and thereafter incorporated into the resulting outsourcing contract.

The print capacity requirements can be adjusted for future years and an outsourcing contract can be developed utilizing the Bass diffusion model and further forecast information, such as the outsourcing contract, which is priced more competitively. Similarly, if the electronic presentment is a part of the contract, the capability to handle the electronic presentment can be adjusted.

The aforementioned diffusion model can be employed to estimate the decline in the number of printed statement. The estimated demand for the rendered documents can be utilized to determine print and mail capacities in subsequent time periods. The outsourcing contract can be written based on the declining requirement for a print job, wherein the capacity and the cost are kept variable over the subsequent years. The outsourcing contract can be priced utilizing such quantitative predictions, thereby leading to a more competitive proposal. Such an approach may lead to a more optimal contract, and therefore improve competitiveness of a vendor associated with such a contract.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a graphical representation of a network of data-processing system, in accordance with an embodiment;

FIG. 4 illustrates a block diagram of an outsourcing contract generating system, in accordance with an embodiment;

FIG. 5 illustrates a high level flow chart of operation illustrating logical operational steps of a method for generating a multi-year variable priced outsourcing contract based on a long term demand forecast utilizing a diffusion model, in accordance with an embodiment;

FIG. 6 illustrates a graph representing a percentage adoption associated with an electronic presentment capability versus time, in accordance with an embodiment; and

FIG. 7 illustrates a graph representing number of adopters associated with the electronic presentment capability utilizing the Bass diffusion model, in accordance with an embodiment.

### DETAILED-DESCRIPTION

The particular values and configurations discussed in these non-limiting examples can be varied and are cited merely to illustrate one or more embodiments and are not intended to limit the scope thereof.

The disclosed method and system can be utilized for generating a multi-year variable priced outsourcing contract based on a long term demand forecast. The system proactively forecasts a future print demand utilizing an estimation of customers migrated to an electronic presentment process and generates the outsourcing contract, which is discussed in greater detail herein. The following discussion is intended to provide a brief, general description of suitable computing environments in which the method and system may be implemented. Although not required, the method and system will be described in the general context of computer-executable instructions, such as program modules, being executed by a single computer.

Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

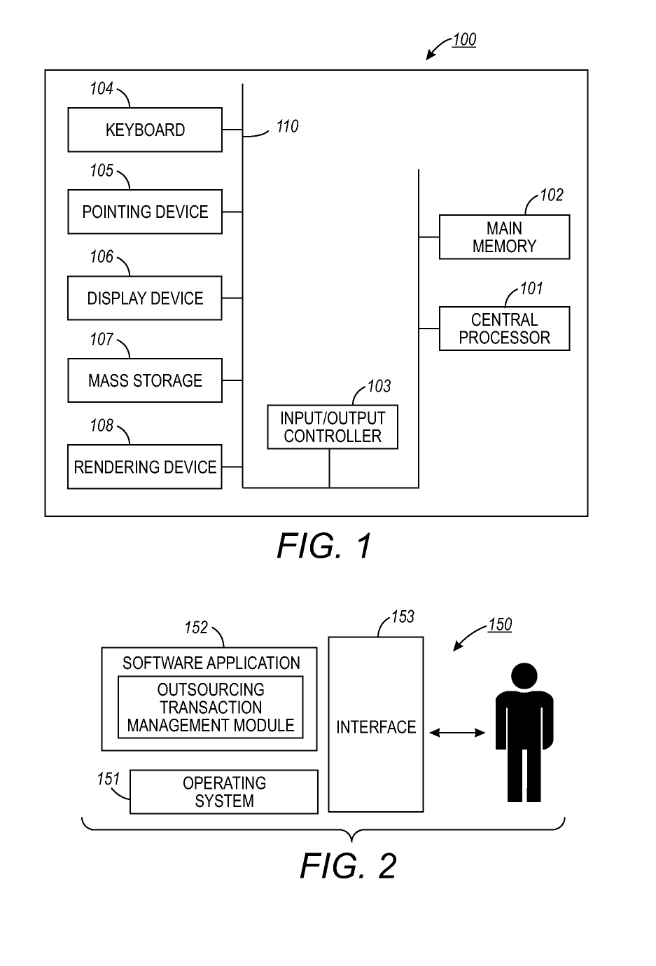

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108, may be included in the data-processing apparatus 100 as desired. Note that the rendering device 108 may constitute, for example, a printer, a copier, fax machine, scanner, and/or other types of rendering components, depending upon design considerations. As illustrated, the various components of the data-processing apparatus 100 communicate through a system bus 110 or similar architecture. It can be appreciated that the data-processing apparatus 100 may be in some embodiments, a mobile computing device such as a Smartphone, a laptop computer, and iPhone, etc. In other embodiments, data-processing apparatus 100 may function as a desktop computer, server, and the like, depending upon design considerations.

FIG. 2 illustrates a computer software system 150 for directing the operation of the data-processing apparatus 100 depicted in FIG. 1. Software application 152, stored in main memory 102 and on mass storage 107, includes a kernel or operating system 151 and a shell or interface 153. One or more application programs, such as software application 152, may be “loaded” (i.e., transferred from mass storage 107 into the main memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 153.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program design to assist in the performance of a specific task, such as word processing, accounting, inventory management, etc.

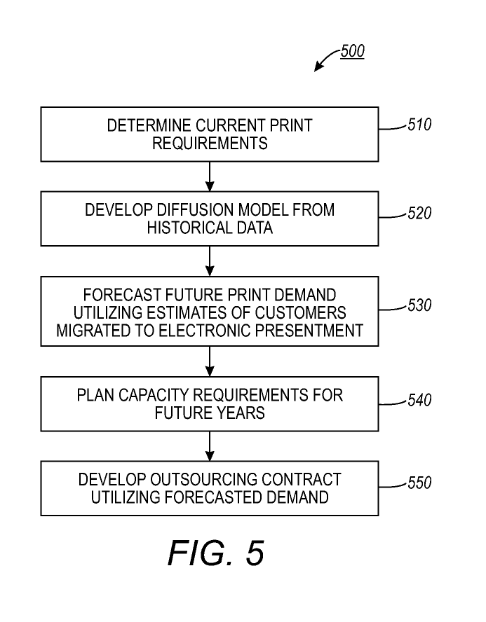

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems, such as, for example, Linux may also be employed with respect to operating system 151 and interface 152. The software application 152 can include an outsourcing transaction management module that can be adapted for estimating a demand for rendered documents and to determine the print and mail capacity in subsequent terms of the contract. Module 152 can be adapted for effectively estimating the future print demand associated with a customer environment. Software application module 152, on the other hand, can include instructions, such as the various operations described herein with respect to the various components and modules described herein, such as, for example, the method 500 depicted in FIG. 5.

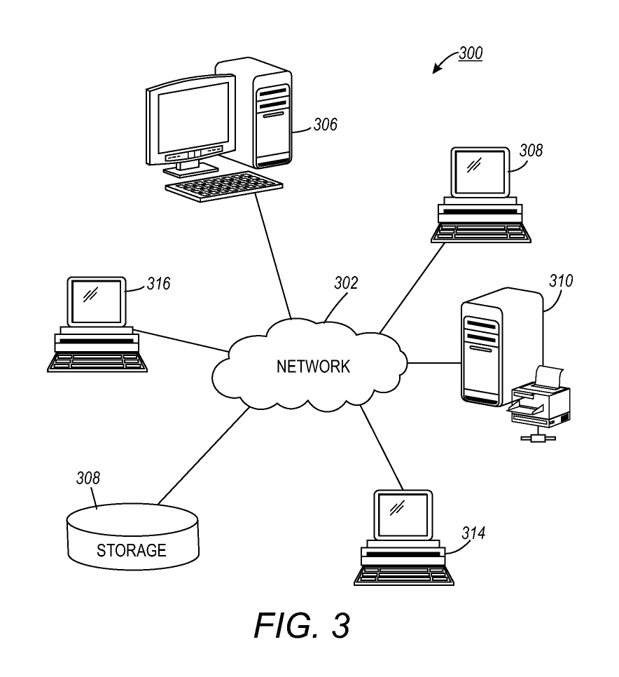

FIG. 3 depicts a graphical representation of a network of data processing systems in which aspects of the present invention may be implemented. Network data processing system 300 can be provided as a network of computers in which embodiments of the present invention may be implemented. Network data processing system 300 contains network 302, which is the medium used to provide communications links between various devices and computers connected together within network data processing apparatus 100. Network 102 may include connections, such as wire, wireless communication links, or fiber optic cables.

In the depicted example, server 306 connects to network 302 along with storage unit 308. The server 306 may be any of a wide variety of well-known computing devices, including, for example, a personal computer, a workstation, a mainframe, a server, and the like. The storage unit 308 may be any of a wide variety of storage devices, including, for example, magnetic storage systems, such as tape or disk, optical storage systems, such as CD or DVD systems, and solid state systems, such as RAM or ROM, and the like. The server 306 may be electrically connected for communication directly to the storage unit 308. In addition, clients 314 and 316 connect to network 302. The client 314 and 316 may be, for example, personal computers or network computers. Data-processing apparatus 100 depicted in FIG. 1 can be, for example, a client such as client 314 and 316. Alternatively, data-processing apparatus 100 can be implemented as a server, such as server 306, depending upon design considerations.

Network data processing system 300 further include one or more rendering devices 108 and a printer server 310 in operative communication with the rendering devices 108 and the computer terminal 314 and 316. The printer server 310 can act as an operative communication medium between the user computer terminal 314 and 316 and the rendering device 108. The printer server 310 is capable of receiving documents for rendering from the user computer terminals 314 and 316 and can select destination network rendering device 108 for routing the documents based on, for example, user preferences or other data.

In general, the rendering device 108 can be utilized to perform a rendering output function (e.g., printing, scanning, copying, faxing, etc) within a networked environment. In the depicted example, server 306 provides data, such as boot files, operating system images, and applications to client 314 and 316. Clients 314 and 316 are client to server 306 in this example. Network data processing system 300 may include additional servers, clients, and other devices not shown. Specifically, clients may connect to any member of a network of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example, and not as an architectural limitation for different embodiments of the present invention.

The following description is presented with respect to embodiments of the present invention, which can be embodied in the context of a data-processing system such as data-processing apparatus 100, computer software system 150 and data-processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

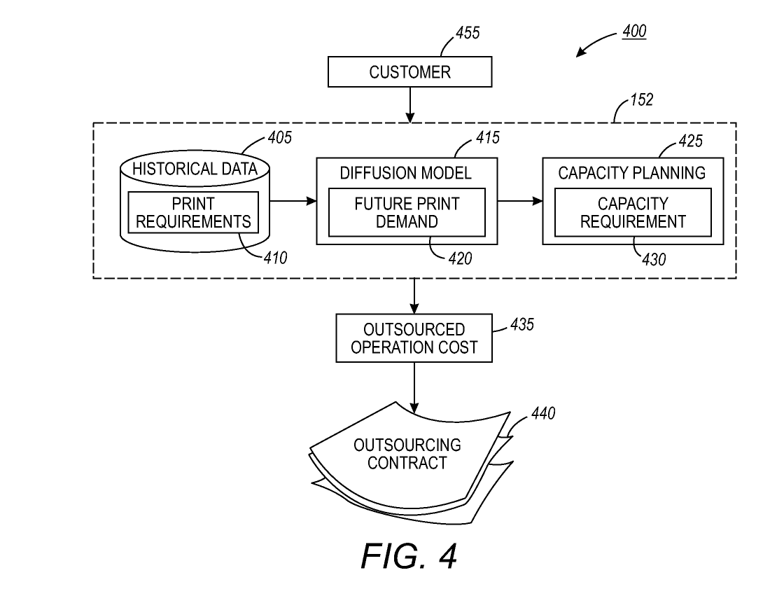

FIG. 4 illustrates a block diagram of an outsourcing contract generating system 400, in accordance with an embodiment. Note that in FIGS. 1-7, identical or similar blocks are generally indicated by identical reference numerals. The outsourcing transaction management module 152 can be stored within the main memory 102 of the computer system 314 and 316. The outsourcing transaction management module 152 provides an outsourced operation cost 435 based on long range demand forecasts. According to the present invention, a customer 455 has various options relating to how the customer 455 will receive the financial statements (e.g., electronic, paper or both). However, the options available to the customer 455 may be limited by the clients on whose behalf the statements are prepared. Instructions relating to the options available to the customers 455 can be included in an implementation profile from each client that uses the services of the processing organization.

The server 306, the database 308, and/or financial statement processing computer 314 and 316 are appropriately programmed, or coded, based on the instructions in the outsourcing transaction management module 152. If the customer 455 elects to receive the financial statement electronically, the server 306 may cause an email to be sent to the customer 455. The statement can also be sent to the rendering device 108 for physical rendering, inserting and mailing. The customer 455 may access the financial statement by connecting to the host computer system 314 and 316. The outsourcing transaction management module 152 can include a diffusion model 415 (e.g., Bass diffusion model) for determining a future print demand 420. Note that the Bass diffusion model 415 can be a mathematical model that describes the process of how new technologies get adopted as an interaction between users and potential users.

The outsourcing transaction management module 152 includes financial transaction information collected and stored utilizing computers and storage devices associated with network data processing system 300. Periodically, the financial transactions can be processed into financial statements for each customer 455 by the computer system 314 and 316. The historical data 405 comprising the print requirements 410 associated with a business process such as, for example, a financial institution can be determined. The Bass diffusion model 415 can be developed from the historical data 405 in order to forecast the future print demand 420 by estimating migration of the customers 455 from a paper document to the electronic presentment process. Note that “electronic presentment” as described herein is the process of delivering traditionally paper-based documents online in electronic formats.

A capacity planning approach 425 (e.g. LDP analysis) can be invoked to determine a capacity requirement 430 (e.g. number of equipment, operators and shift structure) that matches a projected estimate of the future print demand 420 based on the diffusion model 415 when the outsourcing contract 440 is being developed. An outsourced operation cost 435 can then be developed utilizing the capacity requirement 430 and incorporated into the outsourcing contract 440. The print capacity requirements 430 can be adjusted for future years and the outsourcing contract 440 that is priced more competitively can be developed utilizing the Bass diffusion model 415 and the future forecast information 420. For illustrative purposes only, the description of the subject invention is discussed with reference to the document outsourcing contracts associated with financial institution. However, as appreciated by those skilled in the art, other business may also utilize similar methods and incorporate the aspects of the subject invention provided the historical data is available to estimate the market diffusion model.

FIG. 5 illustrates a high level flow chart of operation illustrating logical operational steps of a method 500 for generating the multi-year variable priced outsourcing contract 440 based on a long term demand forecast utilizing the diffusion model 415, in accordance with an embodiment. The current print requirements 410 associated with a business process can be determined, as depicted at block 510. The Bass diffusion model 415 can be developed utilizing the historical data 405, as illustrated at block 520. The future print demand 420 can be forecasted by estimating migration of the customers 455 from the paper document to the electronic presentment process, as indicated at block 530. Also, the capacity requirement 430 for future years can be planned based on the Bass diffusion model 415, as illustrated at block 540. The outsourcing contract 440 can then be generated based on the capacity requirement 430 and forecasted print demand 420, as depicted at block 550. Such an approach can be implemented as a software module such as the outsourcing transaction management module 152 that can be utilized on an ongoing basis by consultants and service sales personnel to adjust the forecasts and propose price adjustments.

The capacity planning approach 425 can be invoked to determine the capacity requirement 430 that match the projections utilizing the Bass diffusion model 415. The outsourcing contract 440 can be written based on the declining requirement for a print job where the capacity requirement 430 and the operation cost 435 can be kept variable over the subsequent years. Such an approach 500 can be generalized to other types of outsourcing contracts provided the historical data 405 is available to estimate the market diffusion model 415. Other variants of the Bass diffusion model 415 (developed over the years) can also be utilized in generating long-term forecasts which can be utilized to plan capacity. Note that the embodiments discussed herein generally relate a variable priced outsourcing contract in the context of a financial institution statement rendering that decline over time. It can be appreciated, however, that such embodiments can be implemented in the context of other systems where the volume of rendered material might increase (e.g. photo-books) over time as a result of diffusion of the product in the market.

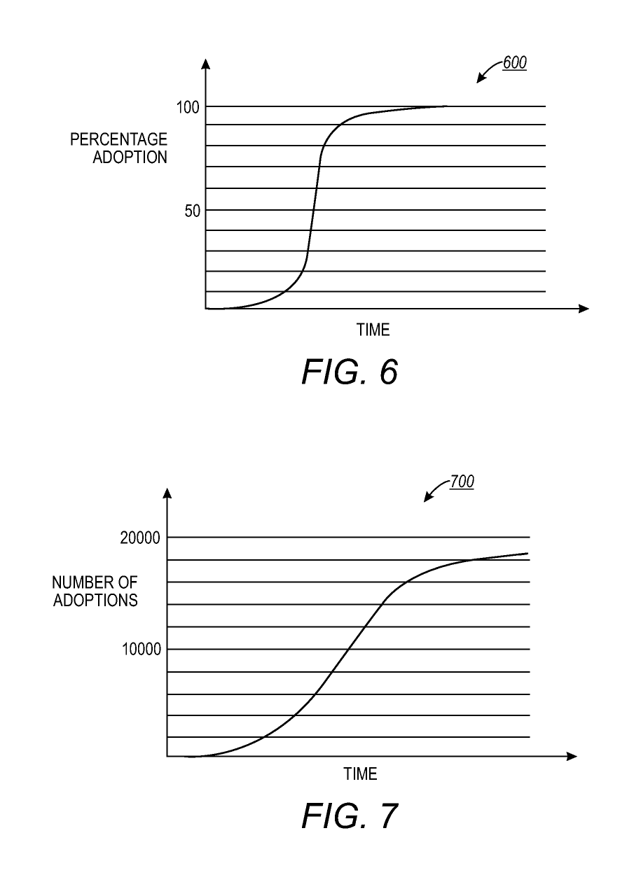

FIG. 6 illustrates a graph 600 representing a percentage adoption associated with the electronic presentment capability versus time, in accordance with an embodiment. Mathematically, the basic bass diffusion is a Riccati equation with constant coefficients and can be represented as follows.

$$\frac{f ( t )}{1 - F ( t )} = p + qF ( t ) \qquad ( 1 )$$

Where f(t) represents the rate of change of the installed base fraction, F(t) represents the installed base fraction, m represents the ultimate market potential, p represents the coefficient of innovation the external influence or advertising effect and q represents the coefficient of imitation the internal influence or word-of-mouth effect.

The sales S(t) can be the rate of change of installed base (i.e. adoption) f(t) multiplied by the ultimate market potential m. The sales S(t) can be represented as follows:

$$\begin{matrix}S ( t ) = mf ( t ) & ( 2 ) \\ S ( t ) = m \frac{{( p + q )}^{2}}{p} \frac{{e}^{- ( p + q ) t}}{{( 1 + {}_{p}^{q}{e}{}_{}^{- ( p + q ) t} )}^{2}} & ( 3 )\end{matrix}$$

The time of peak sales t* can be represented as follows:

$${t}^{*} = \frac{{Ln}_{p}^{q}}{( p + q )} \qquad ( 4 )$$

The average value of p has been found to be 0.02, and is often less than 0.01 and the average value of q is 0.38, with a typical range between 0.3 and 0.5. The Bass diffusion model fits the data for almost all the product introductions, despite a wide range of managerial decision variables, such as for example, pricing and advertising. By considering the above equations and results, the decision variable can shift the bass curve 610 in time, but that the shape of the curve 610 is always similar.

FIG. 7 illustrates a graph 700 representing number of customers associated with the electronic presentment capability utilizing the Bass diffusion model 415, in accordance with an embodiment. The curve 710 depicts the number of adopters of a new technology over time. The Bass diffusion model 415 for the number of adopters of electronic presentment can be estimated utilizing the historical data 405. The determined number of adopters can be further utilized to estimate the number of clients who can still continue to opt for rendered statements within the financial institution. For example, consider that the number of statements being rendered within the financial institution for a time period of 1 year may be 20M. Then, the Bass diffusion model 415 can predict that the number of statements being rendered in next two consecutive years can be as 18M and 14M respectively.

The proposed approach can utilize the predictions of the Bass diffusion model 415 and develops estimation for cost of operating the outsourced operation. The estimated cost 435 can be further incorporated into the outsourcing contract 440. For example, consider that the outsourcing vendor may determine that it requires a 2-shift operation to meet customer requirement in first year of contract; a 2-shift operation with reduced headcount in second shift in second year and a 1-shift operation in third year of contract in order to fulfill the declining demand. Such outsourcing contracts 440 based on a long term demand forecast can provide a number of advantages to the financial organizations that includes, reducing costs, increasing returns on investments, improving process performance, providing greater operational flexibility and transforming existing processes. The outsourcing contract 440 can therefore be priced accordingly by considering such quantitative predictions into account thereby leading to a more competitive proposal.

Based on the foregoing, it can be appreciated that in accordance with the aforementioned embodiments, a method is disclosed for generating a variable priced contract. Such a method generally includes the steps of developing a diffusion model with respect to historical data in order to forecast a future print demand by estimating a number of customers migrating to an electronic presentment process; invoking a capacity planning approach to determine one or more capacity requirements that match a projected estimate of the future print demand based on the diffusion model; and developing an outsourced operation cost utilizing the capacity requirement(s) in order to thereafter incorporate the outsourced operation cost and the future print demand into a variable capacity outsourcing contract, thereby improving a competitiveness of a vendor associated with the outsourcing contract.

Such a method can further include the steps of determining a plurality of print requirements associated with the historical data with respect to a business process, determining a print and mail capacity for subsequent years utilizing the future print demand, and/or adjusting a capability to handle the electronic presentment process if the electronic presentment process is associated with the outsourcing contract. Additional steps can also include developing the outsourcing contract based on a declining requirement associated with a print job, wherein the capacity requirement and the outsourced operation cost is maintained in a variable state over the subsequent years, developing the outsourcing contract based on an increasing requirement associated with the print job, and/or determining the outsourcing contract utilizing a quantitative prediction in order to generate, to a competitive proposal. The aforementioned diffusion model may constitute a Bass diffusion model.

It can be further appreciated, based on the foregoing, that a system for generating a variable priced contract, in accordance with the disclosed embodiments. An embodiment of such a system may include a processor, a data bus coupled to the processor, and a computer-usable medium embodying computer code, the computer-usable medium being coupled to the data bus. The computer program code generally includes instructions executable by the processor and configured for developing a diffusion model with respect to historical data in order to forecast a future print demand by estimating a number of customers migrating to an electronic presentment process; invoking a capacity planning approach to determine one or more capacity requirements that match a projected estimate of the future print demand based on the diffusion model; and developing an outsourced operation cost utilizing the capacity requirement(s) in order to thereafter incorporate the outsourced operation cost and the future print demand into a variable capacity outsourcing contract, thereby improving a competitiveness of a vendor associated with the outsourcing contract.

Such instructions may be further configured for determining a plurality of print requirements associated with the historical data with respect to a business process, for determining a print and mail capacity for subsequent years utilizing the future print demand, for adjusting a capability to handle the electronic presentment process if the electronic presentment process is associated with the outsourcing contract, for developing the outsourcing contract based on a declining requirement associated with a print job, wherein the capacity requirement and the outsourced operation cost is maintained in a variable state over the subsequent years, for developing the outsourcing contract based on an increasing requirement associated with the print job, and/or for determining the outsourcing contract utilizing a quantitative prediction in order to generate to a competitive proposal. Again, the diffusion model may constitute a Bass diffusion model.

It can be further appreciated based on the foregoing, that a computer-usable medium for generating a variable priced contract is disclosed, wherein computer-usable medium embodies computer program code. Such computer program code may include computer executable instructions configured for: developing a diffusion model with respect to historical data in order to forecast a future print demand by estimating a number of customers migrating to an electronic presentment process; invoking a capacity planning approach to determine one or more capacity requirements that match a projected estimate of the future print demand based on the diffusion model; and developing an outsourced operation cost utilizing the capacity requirement(s) in order to thereafter incorporate the outsourced operation cost and the future print demand into a variable capacity outsourcing contract, thereby improving a competitiveness of a vendor associated with the outsourcing contract.

The embodied computer program code can further include computer executable instructions configured for determining a plurality of print requirements associated with the historical data with respect to a business process; developing the diffusion model with respect to the historical data further comprises determining a print and mail capacity for subsequent years utilizing the future print demand; and/or adjusting a capability to handle the electronic presentment process if the electronic presentment process is associated with the outsourcing contract. Such computer executable instructions can be further configured for determining the outsourcing contract utilizing a quantitative prediction in order to generate to a competitive proposal. Additionally, in the context of such a computer-usable medium, the diffusion model may be, for example, a Bass diffusion model.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for generating a variable priced contract, said method comprising:
developing a diffusion model with respect to historical data in order to forecast a future print demand by estimating a number of customers migrating to an electronic presentment process;
invoking a capacity planning approach to determine at least one capacity requirement that matches a projected estimate of said future print demand based on said diffusion model;
developing an outsourced operation cost utilizing said at least one capacity requirement in order to thereafter incorporate said outsourced operation cost and said future print demand into a variable capacity outsourcing contract, thereby improving a competitiveness of a vendor associated with said outsourcing contract.

2. The method of claim 1 further comprising determining a plurality of print requirements associated with said historical data with respect to a business process.

3. The method of claim 1 wherein developing said diffusion model with respect to said historical data further comprises determining a print and mail capacity for subsequent years utilizing said future print demand.

4. The method of claim 1 further comprising adjusting a capability to handle said electronic presentment process if said electronic presentment process is associated with said outsourcing contract.

5. The method of claim 3 further comprising developing said outsourcing contract based on a declining requirement associated with a print job, wherein said capacity requirement and said outsourced operation cost is maintained in a variable state over said subsequent years.

6. The method of claim 5 further comprising developing said outsourcing contract based on an increasing requirement associated with said print job.

7. The method of claim 1 further comprising determining said outsourcing contract utilizing a quantitative prediction in order to generate to a competitive proposal.

8. The method of claim 1 wherein said diffusion model comprises a Bass diffusion model.

9. A system for generating a variable priced contract, said system comprising:
a processor;
a data bus coupled to said processor; and
a computer-usable medium embodying computer code, said computer-usable medium being coupled to said data bus, said computer program code comprising instructions executable by said processor and configured for:
developing a diffusion model with respect to historical data in order to forecast a future print demand by estimating a number of customers migrating to an electronic presentment process;
invoking a capacity planning approach to determine at least one capacity requirement that matches a projected estimate of said future print demand based on said diffusion model; and
developing an outsourced operation cost utilizing said at least one capacity requirement in order to thereafter incorporate said outsourced operation cost and said future print demand into a variable capacity outsourcing contract, thereby improving a competitiveness of a vendor associated with said outsourcing contract.

10. The system of claim 9 wherein said instructions are further configured for determining a plurality of print requirements associated with said historical data with respect to a business process.

11. The system of claim 9 wherein said instructions for developing said diffusion model with respect to said historical data are further configured for determining a print and mail capacity for subsequent years utilizing said future print demand.

12. The system of claim 9 wherein said instructions are further configured for adjusting a capability to handle said electronic presentment process if said electronic presentment process is associated with said outsourcing contract.

13. The system of claim 11 wherein said instructions are further configured for developing said outsourcing contract based on a declining requirement associated with a print job, wherein said capacity requirement and said outsourced operation cost is maintained in a variable state over said subsequent years.

14. The system of claim 13 wherein said instructions are further configured for developing said outsourcing contract based on an increasing requirement associated with said print job.

15. The system of claim 9 wherein said instructions are further configured for determining said outsourcing contract utilizing a quantitative prediction in order to generate to a competitive proposal.

16. The system of claim 9 wherein said diffusion model comprises a Bass diffusion model.

17. A computer-usable medium for generating a variable priced contract, said computer-usable medium embodying computer program code, said computer program code comprising computer executable instructions configured for:
developing a diffusion model with respect to historical data in order to forecast a future print demand by estimating a number of customers migrating to an electronic presentment process;
invoking a capacity planning approach to determine at least one capacity requirement that matches a projected estimate of said future print demand based on said diffusion model;
developing an outsourced operation cost utilizing said at least one capacity requirement in order to thereafter incorporate said outsourced operation cost and said future print demand into a variable capacity outsourcing contract, thereby improving a competitiveness of a vendor associated with said outsourcing contract.

18. The computer-usable medium of claim 17 wherein said embodied computer program code further comprises computer executable instructions configured for:
determining a plurality of print requirements associated with said historical data with respect to a business process;
developing said diffusion model with respect to said historical data further comprises determining a print and mail capacity for subsequent years utilizing said future print demand; and
adjusting a capability to handle said electronic presentment process if said electronic presentment process is associated with said outsourcing contract.

19. The computer-usable medium of claim 17 wherein said embodied computer program code further comprises computer executable instructions configured for determining said outsourcing contract utilizing a quantitative prediction in order to generate to a competitive proposal.

20. The computer-usable medium of claim 17 wherein said diffusion model comprises a Bass diffusion model.
